(19) United States
(12) Patent Application Publication
(10) Pub. No.: US 2024/0265576 A1
(43) Pub. Date: Aug. 8, 2024

(54) DYNAMIC TIME OF CAPTURE

(71) Applicant: Arriver Software AB, Linköping (SE)

(72) Inventors: Hakan AXELSSON, Linköping (SE); Bjoern LOEFGREN, LINKÖPING (SE); Carl RADHOLM, Vikingstad (SE); Ekhiotz VERGARA, Linköping (SE)

(21) Appl. No.: 18/165,873

(22) Filed: Feb. 7, 2023

(51) Int. Cl. G06T 7/80; H04N 23/73; H04N 23/741

(52) U.S. Cl. CPC G06T 7/80; H04N 23/73; H04N 23/741; G06T 2207/10144; G06T 2207/20208

(57) ABSTRACT

Techniques are described herein for processing image data. For instance, a process can include obtaining a respective exposure time for each exposure of a set of exposures for an output image, wherein each respective exposure of the set of exposures contribute to the output image; determining a respective beginning time for each exposure of the set of exposures based on each respective exposure time and an end time to an exposure period for the set of exposures; determining an original beginning time based on each respective beginning time for each exposure of the set of exposures; adjusting the original beginning time based on an amount by which each respective exposure of the set of exposures contribute to the output image to obtain an adjusted beginning time; and determining a time stamp for the output image based on the adjusted beginning time and the end time to the exposure period.

### TECHNICAL FIELD

The present disclosure generally relates to image processing. For example, aspects of the present disclosure relate to systems and techniques for determining a dynamic time of capture for captured images, such as high dynamic range (HDR) images and/or other images.

### BACKGROUND

A camera is a device that receives light and captures image frames, such as still images or video frames, using an image sensor. Cameras may include one or more processors, such as image signal processors (ISPs), that can process one or more image frames captured by an image sensor. For example, a raw image frame captured by an image sensor can be processed by an image signal processor (ISP) to generate a final image. Cameras can be configured with a variety of image capture and image processing settings to alter the appearance of an image. Some camera settings are determined and applied before or while an image is captured, such as ISO, exposure time (also referred to as exposure duration), aperture size, f/stop, shutter speed, focus, and gain, among others. Moreover, some camera settings can be configured for post-processing of an image, such as alterations to a contrast, brightness, saturation, sharpness, levels, curves, and colors, among others.

In some cases, images generated by cameras may be used by computer vision systems which may detect objects or otherwise analyze the scene, as imaged by the camera. As an example, a computer vision system may detect and track objects in the environment by detecting an object in an image taken at a certain time and the object in another image taken at a later time. Based on a change in a location of the object in the images, the computer vision system may be able to determine information about the object, such as a speed other the object, direction of travel, and the like. Thus, being able to determine a precise time when an image is taken may be useful for computer vision systems.

### BRIEF SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In one illustrative example an apparatus for processing image data is provided. The apparatus includes at least one memory and at least one processor coupled to the at least one memory. The at least one processor is configured to: obtain a respective exposure time for each exposure of a set of exposures for an output image, wherein each respective exposure of the set of exposures contribute to the output image; determine a respective beginning time for each exposure of the set of exposures based on each respective exposure time and an end time to an exposure period for the set of exposures; determine an original beginning time based on each respective beginning time for each exposure of the set of exposures; adjust the original beginning time based on an amount by which each respective exposure of the set of exposures contribute to the output image to obtain an adjusted beginning time; and determine a time stamp for the output image based on the adjusted beginning time and the end time to the exposure period.

As another example, a method for processing image data is provided. The method includes: obtaining a respective exposure time for each exposure of a set of exposures for an output image, wherein each respective exposure of the set of exposures contribute to the output image; determining a respective beginning time for each exposure of the set of exposures based on each respective exposure time and an end time to an exposure period for the set of exposures; determining an original beginning time based on each respective beginning time for each exposure of the set of exposures; adjusting the original beginning time based on an amount by which each respective exposure of the set of exposures contribute to the output image to obtain an adjusted beginning time; and determining a time stamp for the output image based on the adjusted beginning time and the end time to the exposure period.

In another example, a non-transitory computer-readable medium having stored thereon instructions is provided. The instructions, when executed by at least one processor, cause the at least one processor to: obtain a respective exposure time for each exposure of a set of exposures for an output image, wherein each respective exposure of the set of exposures contribute to the output image; determine a respective beginning time for each exposure of the set of exposures based on each respective exposure time and an end time to an exposure period for the set of exposures; determine an original beginning time based on each respective beginning time for each exposure of the set of exposures; adjust the original beginning time based on an amount by which each respective exposure of the set of exposures contribute to the output image to obtain an adjusted beginning time; and determine a time stamp for the output image based on the adjusted beginning time and the end time to the exposure period.

As another example, an apparatus for processing image data is provided. The apparatus includes: means for obtaining a respective exposure time for each exposure of a set of exposures for an output image, wherein each respective exposure of the set of exposures contribute to the output image; means for determining a respective beginning time for each exposure of the set of exposures based on each respective exposure time and an end time to an exposure period for the set of exposures; means for determining an original beginning time based on each respective beginning time for each exposure of the set of exposures; means for adjusting the original beginning time based on an amount by which each respective exposure of the set of exposures contribute to the output image to obtain an adjusted beginning time; and means for determining a time stamp for the output image based on the adjusted beginning time and the end time to the exposure period.

In some aspects, one or more of the apparatuses described herein is, can be part of, or can include a mobile device, a smart or connected device, a camera system, and/or an extended reality (XR) device (e.g., a virtual reality (VR) device, an augmented reality (AR) device, or a mixed reality (MR) device). In some examples, the apparatuses can include or be part of a mobile device (e.g., a mobile telephone or so-called “smart phone” or other mobile device), a wearable device, a personal computer, a laptop computer, a tablet computer, a server computer, a robotics device or system, vehicle, or other device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example architecture of an image processing system, in accordance with some examples of the present disclosure;

FIG. 2 illustrates multiple images with different exposures used to create a fused high dynamic range image, in accordance with some examples of the present disclosure;

FIG. 3 illustrates multiple images with different exposures used to create a fused HDR image;

FIG. 4 is a conceptual diagram that illustrates differences between images that are captured by an image capturing system with different exposure times in accordance with some aspects of the disclosure;

FIGS. 5A and 5B are timelines illustrating obtaining time stamps for HDR images, in accordance with aspects of the present disclosure;

FIG. 6 is a timeline illustrating exposures for a pixel of a row during an exposure period, in accordance with aspects of the present disclosure;

FIG. 7 is a flow diagram for a process for processing image data, in accordance with aspects of the present disclosure;

FIG. 8 illustrates an example computing device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

Electronic devices (e.g., mobile phones, wearable devices (e.g., smart watches, smart glasses, etc.), tablet computers, extended reality (XR) devices (e.g., virtual reality (VR) devices, augmented reality (AR) devices, mixed reality (MR) devices, and the like), connected devices, laptop computers, vehicles, etc.) are increasingly equipped with camera hardware to capture image frames, such as still images and/or video frames, for consumption. For example, an electronic device can include a camera to allow the electronic device to capture a video or image of a scene, a person, an object, etc. A camera is a device that receives light and captures image frames (e.g., still images or video frames) using an image sensor. In some examples, a camera may include one or more processors, such as image signal processors (ISPs), that can process one or more image frames captured by an image sensor. For example, a raw image frame captured by an image sensor can be processed by an image signal processor (ISP) of a camera to generate a final image. In some cases, an electronic device implementing a camera can further process a captured image or video for certain effects (e.g., compression, image enhancement, image restoration, scaling, framerate conversion, etc.) and/or certain applications such as computer vision, extended reality (e.g., augmented reality, virtual reality, and the like), object detection, image recognition (e.g., face recognition, object recognition, scene recognition, etc.), feature extraction, authentication, and automation, among others.

Moreover, cameras can be configured with a variety of image capture and image processing settings to alter the appearance of an image. Some camera settings can be determined and applied before or while an image is captured, such as ISO, exposure time (also referred to as exposure duration), aperture size, f/stop, shutter speed, focus, and gain, among others. Some camera settings can be configured for post-processing of an image, such as alterations to a contrast, brightness, saturation, sharpness, levels, curves, and colors, among others. In some examples, a camera can be configured with certain settings to adjust the exposure of an image captured by the camera.

In photography, the exposure of an image captured by a camera refers to the amount of light per unit area that reaches a photographic film, or in modern cameras, an electronic image sensor. The exposure is based on certain camera settings such as, for example, shutter speed, exposure time, and/or lens aperture, as well as the luminance of the scene being photographed. Many cameras are equipped with an automatic exposure or “auto exposure” mode, where the exposure settings (e.g., shutter speed, exposure time, lens aperture, etc.) of the camera may be automatically adjusted to match, as closely as possible, the luminance of a scene or subject being photographed. In some cases, an automatic exposure control (AEC) engine can perform AEC to determine exposure settings for an image sensor. (e.g., exposure time, gain, aperture, etc.).

In photography and videography, a technique called high dynamic range (HDR) allows the dynamic range of image frames captured by a camera to be increased beyond the native capability of the camera. In this context, a dynamic range refers to the range of luminosity between the brightest area and the darkest area of the scene or image frame. For example, a high dynamic range means there is a lot of variation in light levels within a scene or an image frame. HDR can involve capturing multiple image frames of a scene with different exposures and combining captured image frames with the different exposures into a single image frame. The combination of image frames with different exposures can result in an image with a dynamic range higher than that of each individual image frame captured and combined to form the HDR image frame. For example, the electronic device can create a high dynamic range scene by fusing two or more exposure frames into a single frame. HDR is a feature often used by electronic devices, such as smartphones and mobile devices, for various purposes. For example, in some cases, a smartphone can use HDR to achieve a better image quality or an image quality similar to the image quality achieved by a digital single-lens reflex (DSLR) camera.

In some examples, the electronic device can create an HDR image using multiple image frames with different exposures. For example, the electronic device can create an HDR image using a short exposure (SE) image, a medium exposure (ME) image, and a long exposure (LE) image. As another example, the electronic device can create an HDR image using an SE image and an LE image. In some cases, the electronic device can write the different image frames from camera frontends to a memory device, such as a double data rate (DDR) synchronous dynamic random-access memory (SDRAM) or any other memory device. A processing engine can then retrieve the image frames to fuse the image frames into a single image.

Generally, the over-exposed pixels of long exposure images and under-exposed pixels of short exposure images do not contribute to the final fused image (e.g., the HDR image) produced by the HDR algorithm. Nevertheless, the over-exposed pixels of long exposure images and under-exposed pixels of short exposure images are still written from the camera frontend to the memory device and read back from the memory device by the processing engine. Thus, the operations to read and write the over-exposed pixels of long exposure images and under-exposed pixels of short exposure images contribute to the power and bandwidth consumption of the electronic device even though such pixels do not contribute to the final fused image.

In some cases, determining a precise time an image was taken may be useful for a variety of applications, such as image analysis, computer vision, object tracking, object detection, object speed detection, and the like. For example, being able to locate an object or determine a speed of an object precisely may be useful for applications such as automatic emergency braking or lane change assist in a vehicle. Precision in terms of position and speed of an object in world coordinates may depend on precision of when in time the object was present in a scene of the environment. A precise timestamp for when objects are observed in an image can help improve such precision.

Systems, apparatuses, methods (also referred to as processes), and computer-readable media (collectively referred to herein as “systems and techniques”) are described herein for determining a dynamic time of capture for images, such as high dynamic range (HDR) images and/or other images. In some cases, determining a precise time stamp for an HDR (e.g., stacked) image may be problematic as the HDR image may be made up of multiple images each with different exposure times. While a time stamp for an image may be determined based on the middle of a period of time when the different exposures are being taken, objects may move as between the different exposures. A more precise time stamp may take into account on how much a particular exposure contributes to the output image (e.g., final image, final merged image). In some cases, a beginning time of capture may be adjusted to provide a more precise time stamp. For example, the beginning time of capture may be adjusted based on how much a particular exposure contributes to the output image. In some cases, how much a particular exposure contributes to the output image may be determined based any indication of how much a particular exposure, of a set of exposures, was used in the final merged image. Examples of the indication may include a total weight for an exposure, exposure ratio, exposure gain weight, and the like.

Various aspects of the application will be described with respect to the figures.

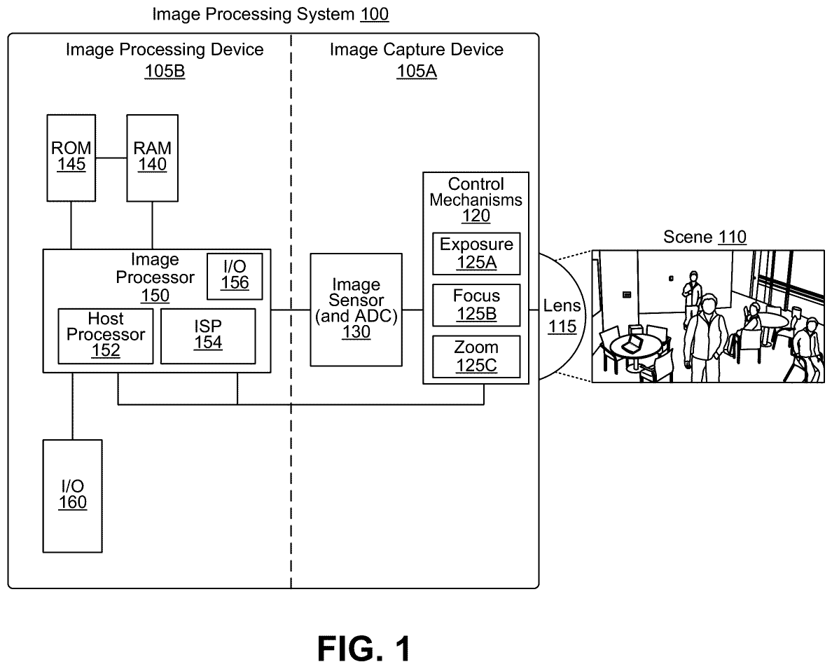

FIG. 1 is a block diagram illustrating an example architecture of an image processing system 100. The image processing system 100 includes various components that are used to capture and process images, such as an image of a scene 110. The image processing system 100 can capture image frames (e.g., still images or video frames). In some cases, the lens 115 and image sensor 130 can be associated with an optical axis. In one illustrative example, the photosensitive area of the image sensor 130 (e.g., the photodiodes) and the lens 115 can both be centered on the optical axis.

In some examples, the lens 115 of the image processing system 100 faces a scene 110 and receives light from the scene 110. The lens 115 bends incoming light from the scene toward the image sensor 130. The light received by the lens 115 then passes through an aperture of the image processing system 100. In some cases, the aperture (e.g., the aperture size) is controlled by one or more control mechanisms 120. In other cases, the aperture can have a fixed size.

The one or more control mechanisms 120 can control exposure, focus, and/or zoom based on information from the image sensor 130 and/or information from the image processor 150. In some cases, the one or more control mechanisms 120 can include multiple mechanisms and components. For example, the control mechanisms 120 can include one or more exposure control mechanisms 125A, one or more focus control mechanisms 125B, and/or one or more zoom control mechanisms 125C. The one or more control mechanisms 120 may also include additional control mechanisms besides those illustrated in FIG. 1. For example, in some cases, the one or more control mechanisms 120 can include control mechanisms for controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting the focus. In some cases, additional lenses may be included in the image processing system 100. For example, the image processing system 100 can include one or more microlenses over each photodiode of the image sensor 130. The microlenses can each bend the light received from the lens 115 toward the corresponding photodiode before the light reaches the photodiode.

In some examples, the focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and the focus control mechanism 125B.

The exposure control mechanism 125A of the control mechanisms 120 can obtain an exposure setting. In some cases, the exposure control mechanism 125A stores the exposure setting in a memory register. Based on the exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, the image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used such as, for example and without limitation, a Bayer color filter array, a quad color filter array (QCFA), and/or any other color filter array.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

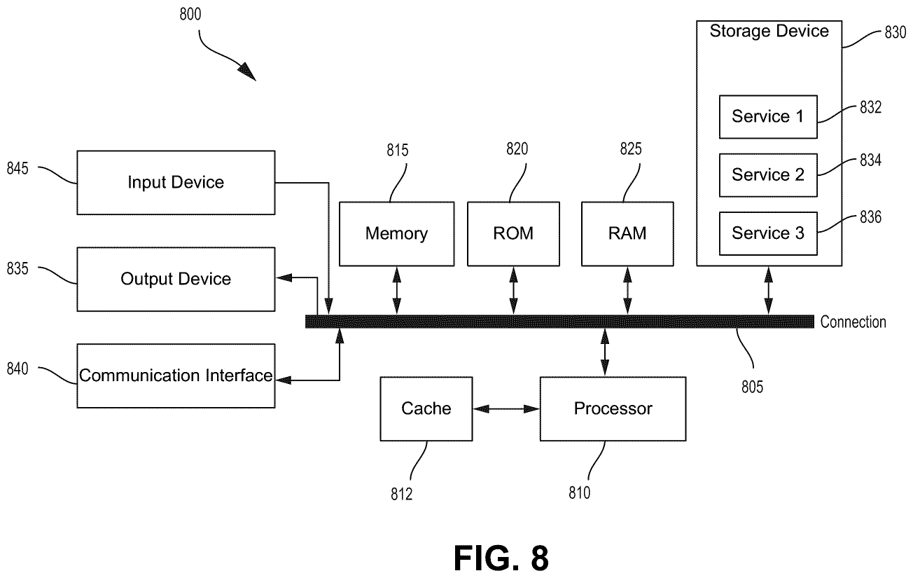

The image processor 150 may include one or more processors, such as one or more image signal processors (ISPs) (including ISP 154), one or more host processors (including host processor 152), and/or one or more of any other type of processor discussed with respect to the computing device architecture 800 of FIG. 8. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140, read-only memory (ROM) 145, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices, any other input devices, or any combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the image processing system 100 and one or more peripheral devices, over which the image processing system 100 may receive data from the one or more peripheral device and/or transmit data to the one or more peripheral devices. The I/O devices 160 may include one or more wireless transceivers that enable a wireless connection between the image processing system 100 and one or more peripheral devices, over which the image processing system 100 may receive data from the one or more peripheral device and/or transmit data to the one or more peripheral devices. The peripheral devices may include any of the previously-discussed types of the I/O devices 160 and may themselves be considered I/O devices 160 once they are coupled to the ports, jacks, wireless transceivers, or other wired and/or wireless connectors.

In some cases, the image processing system 100 may be a single device. In some cases, the image processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A. In some examples, the image processing system 100 can include one or more wireless transceivers for wireless communications, such as cellular network communications, 802.11 Wi-Fi communications, wireless local area network (WLAN) communications, or some combination thereof.

The image processing system 100 can be part of, or implemented by, a single computing device or multiple computing devices. In some examples, the image processing system 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a laptop or notebook computer, a tablet computer, a set-top box, a smart television, a display device, a game console, an XR device (e.g., an HMD, smart glasses, etc.), an IoT (Internet-of-Things) device, a smart wearable device, a video streaming device, an Internet Protocol (IP) camera, a vehicle or any other suitable electronic device(s).

The image capture device 105A and the image processing device 105B can be part of the same electronic device or different electronic devices. In some implementations, the image capture device 105A and the image processing device 105B can be different devices. For instance, the image capture device 105A can include a camera device and the image processing device 105B can include a computing device, such as a mobile device, a desktop computer, a smartphone, a smart television, a game console, a vehicle, or other computing device.

While the image processing system 100 is shown to include certain components, one of ordinary skill will appreciate that the image processing system 100 can include more components than those shown in FIG. 1. The components of the image processing system 100 can include software, hardware, or one or more combinations of software and hardware. For example, in some implementations, the components of the image processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image processing system 100.

The host processor 152 can configure the image sensor 130 with new parameter settings (e.g., via an external control interface such as I2C, I3C, SPI, GPIO, and/or other interface). In one illustrative example, the host processor 152 can update exposure settings used by the image sensor 130 based on internal processing results of an exposure control algorithm from past image frames. The host processor 152 can also dynamically configure the parameter settings of the internal pipelines or modules of the ISP 154 to match the settings of one or more input image frames from the image sensor 130 so that the image data is correctly processed by the ISP 154. Processing (or pipeline) blocks or modules of the ISP 154 can include modules for lens (or sensor) noise correction, de-mosaicing, color conversion, correction or enhancement/suppression of image attributes, denoising filters, sharpening filters, among others. Each module of the ISP 154 may include a large number of tunable parameter settings. Additionally, modules may be co-dependent as different modules may affect similar aspects of an image. For example, denoising and texture correction or enhancement may both affect high frequency aspects of an image. As a result, a large number of parameters are used by an ISP to generate a final image from a captured raw image.

In some examples, the computing device architecture 800 shown in FIG. 8 and further described below can include the image processing system 100, the image capture device 105A, the image processing device 105B, or a combination thereof.

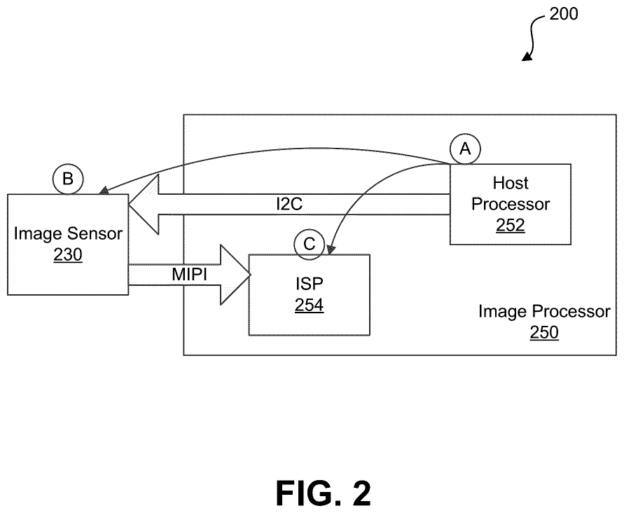

FIG. 2 is a block diagram illustrating an example of an image capture and processing system 200 including an image processor 250 (including host processor 252 and ISP 254) in communication with an image sensor 230. The configuration shown in FIG. 2 is illustrative of traditional synchronization techniques used in camera systems. In general, the host processor 252 attempts to provide synchronization between the image sensor 230 and the ISP 254 using fixed periods of time by separately communicating with the image sensor 230 and the ISP 254. For example, in traditional camera systems, the host processor 252 communicates with the image sensor 230 (e.g., over an I2C port) and programs the image sensor 230 parameters with a first fixed period of time, such as 2-frame periods ahead of when that image frame will be processed by the ISP 254. The host processor 252 communicates with the ISP 254 (e.g., over an internal AHB bus or other interface) and provides the ISP 254 with parameter settings to capture an image withing a second fixed period of time, such as 1-frame period ahead of when that image frame will be processed by the ISP 254. The image sensor 230 can send image frames to the ISP 254 such as over an MIPI CSI-2 PHY port or interface, or other suitable interface.

In some examples, the image processing system 100 can create an HDR image using multiple image frames with different exposures. For example, the image processing system 100 can create an HDR image using a short exposure (SE) image, a medium exposure (ME) image, and a long exposure (LE) image. As another example, the image processing system 100 can create an HDR image using an SE image and an LE image. In some cases, the image processing system 100 can write the different image frames from one or more camera frontend engines to a memory device, such as a DDR memory device or any other memory device. A post-processing engine can then retrieve the image frames and fuse (e.g., merge, combine) them into a single image. As previously explained, the different write and read operations used to create the HDR image can result in significant power and bandwidth consumption.

In some cases, the ISP 254 may receive multiple exposures (e.g., the SE image, ME image, and/or LE image) from the image sensor 230 and process the multiple exposures into a single HDR image. In other cases, the image sensor 230 may include an integrated processor and memory (not shown) for storing and processing multiple exposures (e.g., the SE image, ME image, and/or LE image) into a single HDR image. This HDR image may be passed to the ISP 254 for additional processing. In some cases, the HDR processing for generating the HDR image may also be performed by a system processor, such as the host processor 252.

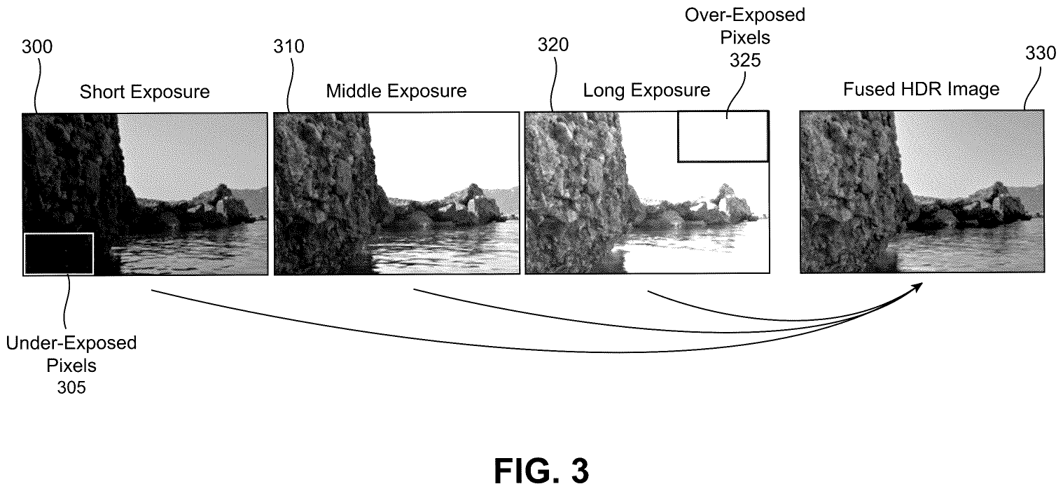

As previously explained, when creating an HDR image, over-exposed pixels of a long exposure image and under-exposed pixels of a short exposure image generally do not contribute to the final HDR image produced by the image processing system 100. For example, FIG. 3 illustrates multiple images with different exposures used to create a fused HDR image (e.g., HDR image 330). In particular, FIG. 3 shows a short exposure image 300, a medium exposure image 310, a long exposure image 320, and an HDR image 330 generated by combining or fusing together the short exposure image 300, the medium exposure image 310, and the long exposure image 320. In some cases, HDR processing to generate the HDR image 330 may be performed by a processor, such as the host processor 252 of FIG. 2, or by a processor that is a component of the ISP 254, or by a processor that is integrated with the image sensor 230.

In some cases, the different exposures (e.g., the short exposure image 300, the medium exposure image 310, and the long exposure image 320) may be fused via an HDR algorithm. In some cases, the HDR algorithm may determine how much influence a particular exposure of a scene has on a final pixel value for the fused image. For example, for a certain pixel of a fused image, the corresponding short exposure image 300 version of the pixel may be underexposed and may not include useful information for the fused image, while the corresponding medium exposure image 310 and long exposure image 320 versions of the pixel may include more useful information for the fused image. Thus, it may be useful to reduce the influence of the corresponding short exposure image 300 version of the pixel or adjust the influence of the corresponding medium exposure image 310 and long exposure image 320 versions of the pixel. In some cases, this adjustment may be performed by adjusting weights applied to the pixels of the different exposures to help control how much influence the different exposures have in a final fused version of a pixel. This weighting may be performed on a pixel by pixel basis, for a whole exposure image, or for some portion of the exposure image. As an example of how weights may be determined, in some cases, weights may be determined based on a luma value for a pixel or group of pixels and weights applied based on a look up table. In some cases a total weight for an exposure (e.g., for the short exposure image 300, the medium exposure image 310, and the long exposure image 320) may be determined by summing weight values applied to the pixels of the exposure and dividing by a total possible weight.

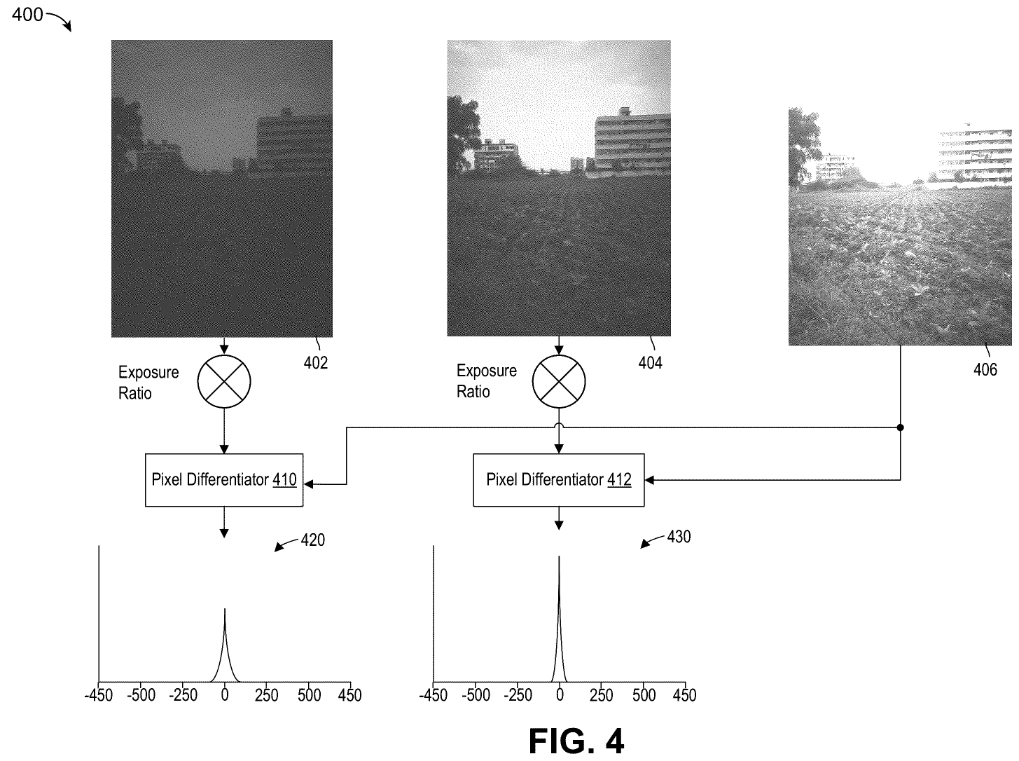

FIG. 4 is a conceptual diagram 400 that illustrates differences between images that are captured by an image capturing system with different exposure times in accordance with some aspects of the disclosure. Diagram 400 illustrates a short-exposure image 402, a medium exposure image 404, and a long-exposure image 406 that are captured by an image processing system. In conventional HDR image synthesis processes, the short-exposure image 402, the medium exposure image 404, and the long-exposure image 406 are provided from an image sensor to an ISP (e.g., ISP 254) for processing. The ISP may store the short-exposure image 402, the medium exposure image 404, and the long-exposure image 406 in a memory and then process the short-exposure image 402, the medium exposure image 404, and the long-exposure image 406 into a single HDR image.

As described above, each of the short-exposure image 402, the medium exposure image 404, and the long-exposure image 406 are read out from the sensor array by the image sensor and have different exposure times but may be directed at the same scene. In some cases, the different exposures may or may not overlap. Diagram 400 illustrates that the short-exposure image 402 is multiplied by the short-to-long-exposure ratio to normalize the short-exposure image 402 in intensity with respect to the long-exposure image 406. For example, if the short-exposure time is 10 milliseconds (ms) and the long-exposure time is 40 ms, the brightness of the pixels in the short-exposure image 402 is multiplied by an exposure ratio of 4.0. The normalized short-exposure image 402 and the long-exposure image 406 are then compared in a pixel differentiator 410. In one illustrative example, the pixel differentiator 410 calculates a difference between each pixel to produce a differential pixel bitmap, and graph 420 illustrates a difference in pixel values between the normalized short-exposure image 402 and the long-exposure image 406. In some cases, the exposure ratio may be used to express the effect of the exposure on the final HDR image.

In some cases, the exposure time and an exposure gain weight may be dynamically determined by an exposure control algorithm. In some cases, the exposure time and an exposure gain weight may be selected based on light conditions of the environment. As discussed above, there can be multiple exposures per pixel with multiple exposure times that maybe used to generate a single HDR image. The exposure gain weight for an exposure may also be used to express the effect of the exposure on the final HDR image.

As discussed above, determining a precise time an image was taken may be useful for a variety of applications, such as image analysis, computer vision, object tracking, object detection, and the like. Of note, for the purposes of this disclosure, time may refer to a relative time for a camera device. That is, the relative time may be independent of a time for the world. For example, when attempting to determine a precise speed of an object, precise time stamps for when an image was taken may be used. However, while those time stamps may be precise with respect to each other and possibly with other sensors and/or systems the camera device includes and/or is coupled to, those time stamps may not be accurate with respect to a time in the environment as measured, for example, by a separate clock.

In some cases, determining a precise time stamp for an HDR (e.g., stacked) image may be problematic as the HDR image may be made up of multiple images each with different exposure times. In some cases, a time stamp for an HDR image may be based on the middle of a period of time when the different exposures are being taken (e.g., exposure period for the HDR image).

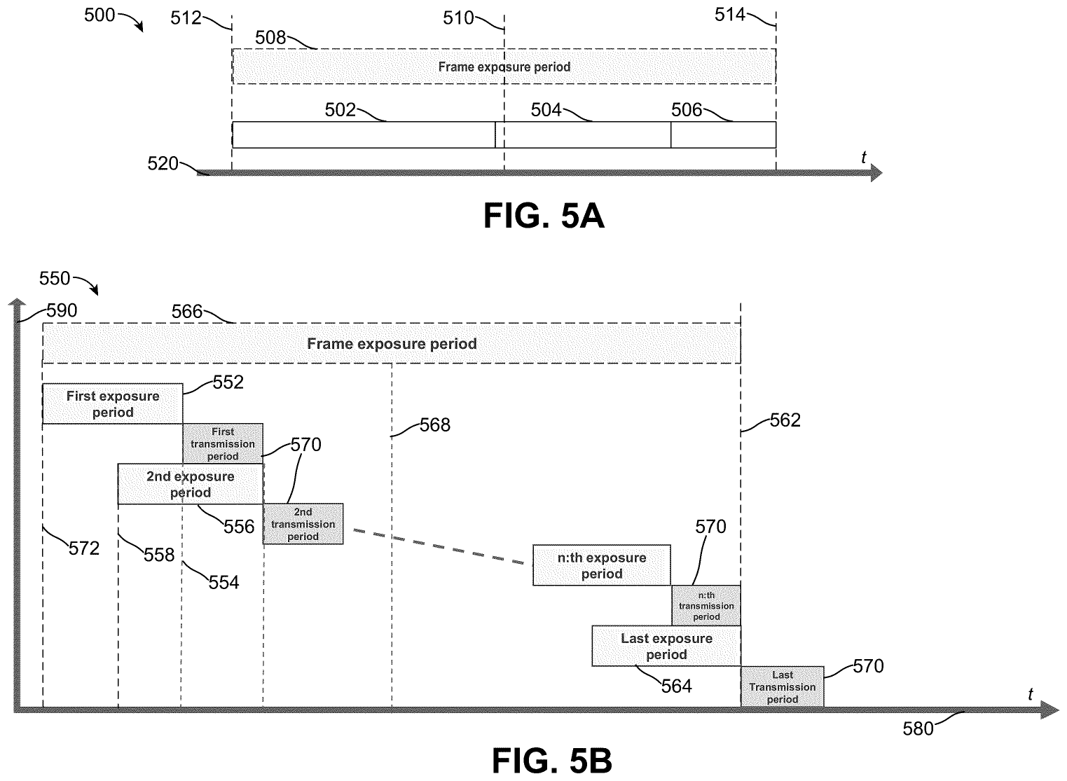

FIGS. 5A and 5B are timelines illustrating obtaining time stamps for images taken with a rolling shutter for generating HDR images, in accordance with aspects of the present disclosure. FIG. 5A, illustrates a timeline 500 for a camera device with a global shutter. In timeline 500, the capturing of different portions of the image data for the HDR image by the imaging system is illustrated relative to a horizontal time axis 520 along which time flows from left to right. In some cases, an HDR image may be based on three images with different exposure periods, a long exposure image 502, a medium exposure image 504, and a short exposure image 506. A frame exposure period 508 may be a length of time used to obtain the exposure images. A time stamp for the HDR image may be the middle 510 of the frame exposure period 508 and the middle 510 may be found by subtracting a beginning time 512 of the frame exposure period 508 from an end time 514 of the frame exposure period and dividing by two.

FIG. 5B illustrates a timeline 550 for a camera device with a rolling shutter. In timeline 550, the capturing of different portions of the image data for the HDR image by the imaging system is illustrated relative to a horizontal time axis 580 along which time flows from left to right, and relative to a vertical row axis 590 indicative of different rows of the image sensor. In some cases, a rolling shutter camera can capture a still image or each frame of a video by scanning across a scene rapidly from one side of the image sensor to another side of the image sensor. In some cases, a rolling shutter may scan across the scene horizontally. In other cases, the rolling shutter may scan across the scene vertically. In some examples, using a rolling shutter, different parts of the image of the scene are recorded at different instants in time. An image captured using a rolling shutter can depict different parts of the scene as they appeared at slightly different times (e.g., instants in time) in the scene. A rolling shutter camera can capture data for pixels line-by-line (e.g., row by row) from one side of the image sensor to the other side of the image sensor.

In timeline 550 a first row may be exposed and captured during a first exposure period 552 where photodetectors of the first row may be exposed to light from the scene. A second exposure period 556 for a second row of photodetectors may be begin 558 prior to an end 554 of the first exposure period 552. The second row may be exposed and captured during the second exposure period 556. This pattern repeats for rows of the image sensor until a last row is exposed and captured at an end 562 of a last exposure period 564. In some cases, a period of time for each exposure period (e.g., first exposure period 552, second exposure period 556, . . . last exposure period 564) is the same and multiple exposures may be generated for a row during the exposure periods.

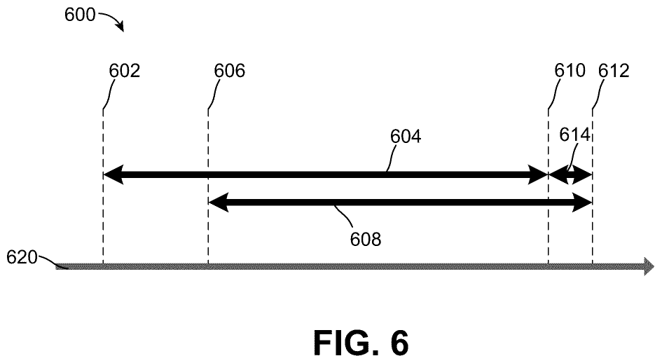

FIG. 6 is a timeline 600 illustrating exposures for a pixel of a row during an exposure period, in accordance with aspects of the present disclosure. In timeline 600, the capturing of data for a pixel of the HDR image by the imaging system is illustrated relative to a horizontal time axis 620 along which time flows from left to right. In some cases, pixel data for three exposures may be captured during an exposure period. In some cases, data for a pixel may be captured by multiple photodetectors as subpixels and merged, such as with a QCFA. In some cases, these multiple subpixels may be used to capture different exposures of an HDR image concurrently. For example, pixel data for a long exposure may be captured by a first subpixel of a pixel starting at a beginning 602 of a long exposure capture period 604 and a medium exposure may be captured by a second subpixel of the pixel starting at a beginning 606 of a medium exposure capture period 608. At an end 610 of the long exposure capture period 604, pixel data for a short exposure may be captured by the first subpixel of the pixel. Capturing pixel data for the short exposure and the medium exposure may end at an end 612 of the exposure period. In some cases, the end 612 of the exposure period may be predetermined. In some cases, exposure times for the long exposure capture period 604, medium exposure capture period 608, and short exposure capture period 614 may be determined by the exposure control algorithm and a start of the exposures may be set based on the predetermined end 612 of the exposure period.

Returning to FIG. 5B, a frame exposure period 566 may be a length of time from a start (e.g., a beginning time of capture 572) of the first exposure period 552 to the end 562 of the last exposure period. A time stamp for the HDR image may be the middle 568 of the frame exposure period 566 and the middle 568 may be found in a substantially similar way as discussed above with respect to FIG. 5A. Transmission periods 570 may be periods of time used to transmit and/or process pixel data from a row.

However, the time stamp may not be very precise depending on how the exposures are merged into the final HDR image. For example, if an HDR image, taken in an environment with very bright lighting, includes a long exposure taken before a medium exposure, which is then followed by a short exposure, the long exposure may only contribute a very little, it at all, to the final HDR image. In such a case, it may be more precise to base the time stamp of the HDR image more on the points in time the medium exposure and short exposure were taken.

In some cases, dynamically adjusting a time of capture for images may result in a more precise time stamp. For example, as indicated above, time stamps for an HDR image may be based on the middle of a frame exposure period, such as frame exposure periods 508 and 566, where the middle of the frame exposure period is based on a starting time and an ending time. In some cases, the middle of the frame exposure period may be dynamically adjusted by adjusting a starting time of the frame exposure period. In some cases, the starting time of the frame exposure period may be adjusted based on starting times of exposures of the merged image and how much the exposures of the merged image contribute to a final merged image. For example, the starting time of the frame exposure period may be adjusted based on how much a particular exposure contributes to the final merged image. How much a particular exposure contributes to the final merged image may be determined via any indication of how much a particular exposure, of a set of exposures, was used in the final merged image. Examples of the indication may include a total weight for an exposure, exposure ratio, exposure gain weight, and the like.

As a more detailed example, as the time of capture for a fused image may be adjusted based on the exposure gain weight, initially, an earliest individual exposure, of a set of exposures for an output image may be determined as an original beginning time of capture. For example, the exposure control algorithm may determine lengths of time for individual exposures of the set of exposures. In some cases, the set of exposures may include three individual exposures, a short exposure, a medium exposure, and a long exposure The exposure control algorithm may determine lengths of time for each of these individual exposures based on environmental conditions, such as lighting conditions, speed of the camera device, acceleration of the camera device, and the like. Based on the determined lengths of time for the individual exposures and an end of an exposure period, original beginning times may be determined for each individual exposure. The original beginning time of capture may be adjusted based on the exposure weight gain by obtaining the exposure gain weight for each of the exposures and applying the exposure gain weight to the individual exposure times of each of the exposures. From the adjusted beginning times, an earliest adjusted beginning time may be identified as an adjusted beginning time of capture.

As a first example for applying the exposure gain weight to the exposure times where the exposures can be captured, at least partially concurrently, if an exposure, such as the medium exposure, has an exposure time (e.g., length of exposure) of 4 ms and the exposure has an exposure gain weight of 0.5, then the exposure may have a weighted exposure time 2 ms. Adjusted beginning times of capture may be determined for each exposure based on the weighted exposure time. From the adjusted beginning times of capture, the earliest adjusted beginning time may be identified as the adjusted beginning time of capture. In some cases, such as where multiple exposures may be captured concurrently, an exposure associated with the original beginning time of capture (e.g., having the earliest original beginning time of capture) may not be the same as an exposure associated with the adjusted beginning time of capture. A time stamp for the fused image may then be determined based on the adjusted beginning time of capture and the end of the frame exposure period. In some cases, the time stamp for the fused image may be determined prior to, concurrently with, or after capturing exposures of the fused image.

As a second example, for applying the exposure gain weight to the exposure times where the individual exposures are sequentially captured, if an individual exposure, such as the medium exposure, has an exposure time (e.g., length of exposure) of 4 ms and the individual exposure has an exposure gain weight of 0.5, then the individual exposure may have a weighted exposure time 2 ms. A weighted exposure time may be determined for each individual exposure and the weighted exposure times may be summed. The original beginning time of capture may be adjusted based on a difference between a sum of the original individual exposure times and the summed weighted exposure times. A time stamp for the fused image may then be determined based on the adjusted beginning time of capture and the end of the frame exposure period.

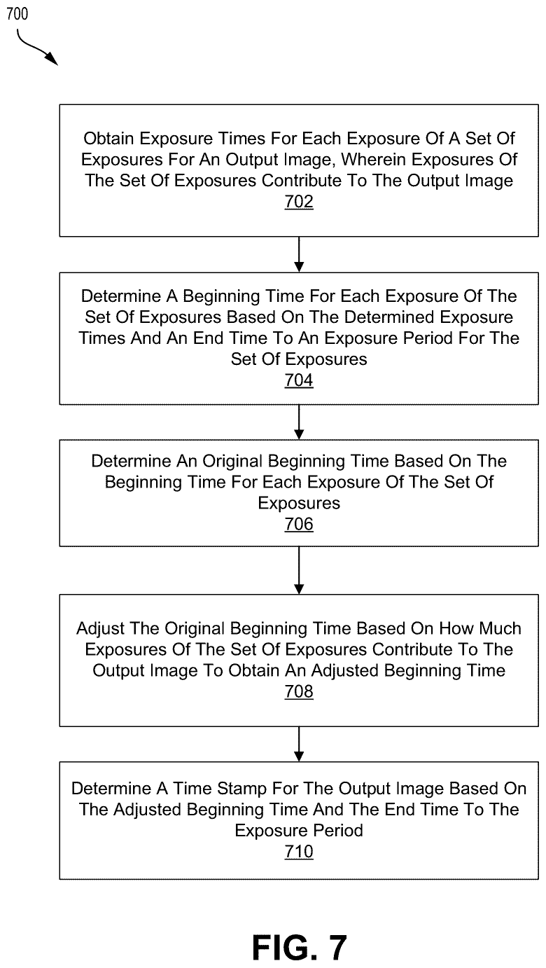

FIG. 7 is a flow diagram for a process 700 for dynamically adjusting an image capture time, in accordance with aspects of the present disclosure. The process 700 may be performed by a computing device (or apparatus) or a component (e.g., a chipset, codec, etc.) of the computing device, such as by image processor 150 of FIG. 1, image sensor 130 of FIG. 1, ISP 254 of FIG. 2, image sensor 230 of FIG. 2, host processor 252 of FIG. 2, and/or processor 810 of FIG. 8. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 700 may be implemented as software components that are executed and run on one or more processors.

At block 702 the computing device (or component thereof) may obtain a respective exposure time for each exposure of a set of exposures for an output image. In some cases, each respective exposure of the set of exposures contribute to the output image.

At block 704 the computing device (or component thereof) may determine a respective beginning time for each exposure of the set of exposures based on each respective exposure time and an end time to an exposure period for the set of exposures. In some cases, the end time to the exposure period is predetermined.

At block 706 the computing device (or component thereof) may determine an original beginning time based on each respective beginning time for each exposure of the set of exposures.

At block 708 the computing device (or component thereof) may adjust the original beginning time based on an amount by which each respective exposure of the set of exposures contribute to the output image to obtain an adjusted beginning time. The computing device (or component thereof) may obtain a respective exposure gain weight for each exposure of the set of exposures. The computing device (or component thereof) may determine the amount by which each respective exposure of the set exposures contributes to the output image based on the respective exposure gain weight for each exposure of the set of exposures. The computing device (or component thereof) may determine the amount by which each respective exposure of the set of exposure contributes to the output image by applying the respective exposure gain weight associated with each exposure to each respective beginning time for each exposure. The computing device (or component thereof) may determine a respective adjusted beginning time for each exposure of the set of exposures based on the original beginning time for each exposure of the set of exposures and the respective exposure gain weight associated with each exposure of the set of exposures. In some cases, to adjust the original beginning time, the computing device (or component thereof) may select an earliest beginning time from the adjusted beginning time for each exposure of the set of exposures as the adjusted beginning time. In some cases, the respective exposure time for each exposure of the set of exposures and the respective exposure gain weight for each exposure of the set of exposures are based on environmental conditions around the apparatus.

At block 710 the computing device (or component thereof) may determine a time stamp for the output image based on the adjusted beginning time and the end time to the exposure period. To determine the time stamp for the output image, the computing device (or component thereof) may determine a middle between the adjusted beginning time and the end time to the exposure period. FIG. 8 illustrates an example computing device architecture 800 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing device architecture 800 may include image processing system 100 of FIG. 1. The components of computing device architecture 800 are shown in electrical communication with each other using connection 805, such as a bus. The example computing device architecture 800 includes a processing unit (CPU or processor) 810 and computing device connection 805 that couples various computing device components including computing device memory 815, such as read only memory (ROM) 820 and random access memory (RAM) 825, to processor 810.

Computing device architecture 800 can include a cache of high-speed memory connected directly with, in close proximity to, or integrated as part of processor 810. Computing device architecture 800 can copy data from memory 815 and/or the storage device 830 to cache 812 for quick access by processor 810. In this way, the cache can provide a performance boost that avoids processor 810 delays while waiting for data. These and other modules can control or be configured to control processor 810 to perform various actions. Other computing device memory 815 may be available for use as well. Memory 815 can include multiple different types of memory with different performance characteristics. Processor 810 can include any general purpose processor and a hardware or software service, such as service 1 832, service 2 834, and service 3 836 stored in storage device 830, configured to control processor 810 as well as a special-purpose processor where software instructions are incorporated into the processor design. Processor 810 may be a self-contained system, containing multiple cores or processors, a bus, memory controller, cache, etc. A multi-core processor may be symmetric or asymmetric.

To enable user interaction with the computing device architecture 800, input device 845 can represent any number of input mechanisms, such as a microphone for speech, a touch-sensitive screen for gesture or graphical input, keyboard, mouse, motion input, speech and so forth. Output device 835 can also be one or more of a number of output mechanisms known to those of skill in the art, such as a display, projector, television, speaker device, etc. In some instances, multimodal computing devices can enable a user to provide multiple types of input to communicate with computing device architecture 800. Communication interface 840 can generally govern and manage the user input and computing device output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof. Storage device 830 can include services 832, 834, 836 for controlling processor 810. Other hardware or software modules are contemplated. Storage device 830 can be connected to the computing device connection 805. In one aspect, a hardware module that performs a particular function can include the software component stored in a computer-readable medium in connection with the necessary hardware components, such as processor 810, connection 805, output device 835, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors, and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific embodiments. For example, a system may be implemented on one or more printed circuit boards or other substrates, and may have movable or static components. While the below description and examples use the term “system” to describe various aspects of this disclosure, the term “system” is not limited to a specific configuration, type, or number of objects.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or other electronic memory devices, magnetic or optical disks, USB devices provided with non-volatile memory, networked storage devices, and/or any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“<”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for processing image data, the apparatus comprising: at least one memory; and at least one processor coupled to the at least one memory and configured to: obtain a respective exposure time for each exposure of a set of exposures for an output image, wherein each respective exposure of the set of exposures contribute to the output image; determine a respective beginning time for each exposure of the set of exposures based on each respective exposure time and an end time to an exposure period for the set of exposures; determine an original beginning time based on each respective beginning time for each exposure of the set of exposures; adjust the original beginning time based on an amount by which each respective exposure of the set of exposures contribute to the output image to obtain an adjusted beginning time; and determine a time stamp for the output image based on the adjusted beginning time and the end time to the exposure period.

Aspect 2. The apparatus of Aspect 1, wherein the end time to the exposure period is predetermined.

Aspect 3. The apparatus of any of Aspects 1-2, wherein the at least one processor is further configured to: obtain a respective exposure gain weight for each exposure of the set of exposures; and determine the amount by which each respective exposure of the set exposures contributes to the output image based on the respective exposure gain weight for each exposure of the set of exposures.

Aspect 4. The apparatus of Aspect 3, wherein the at least one processor is configured to determine the amount by which each respective exposure of the set of exposure contributes to the output image by applying the respective exposure gain weight associated with each exposure to each respective beginning time for each exposure.

Aspect 5. The apparatus of Aspect 3, wherein the at least one processor is further configured to: determine a respective adjusted beginning time for each exposure of the set of exposures based on the original beginning time for each exposure of the set of exposures and the respective exposure gain weight associated with each exposure of the set of exposures.

Aspect 6. The apparatus of Aspect 5, wherein, to adjust the original beginning time, the at least one processor is further configured to select an earliest beginning time from the adjusted beginning time for each exposure of the set of exposures as the adjusted beginning time.

Aspect 7. The apparatus of Aspect 3, wherein the respective exposure time for each exposure of the set of exposures and the respective exposure gain weight for each exposure of the set of exposures are based on environmental conditions around the apparatus.

Aspect 8. The apparatus of any of Aspects 1-7, wherein, to determine the time stamp for the output image, the at least one processor is configured to determine a middle between the adjusted beginning time and the end time to the exposure period.

Aspect 9. A method for processing image data, comprising: obtaining a respective exposure time for each exposure of a set of exposures for an output image, wherein each respective exposure of the set of exposures contribute to the output image; determining a respective beginning time for each exposure of the set of exposures based on each respective exposure time and an end time to an exposure period for the set of exposures; determining an original beginning time based on each respective beginning time for each exposure of the set of exposures; adjusting the original beginning time based on an amount by which each respective exposure of the set of exposures contribute to the output image to obtain an adjusted beginning time; and determining a time stamp for the output image based on the adjusted beginning time and the end time to the exposure period.

Aspect 10. The method of Aspect 9, wherein the end time to the exposure period is predetermined.

Aspect 11. The method of any of Aspects 9-10, further comprising: obtaining a respective exposure gain weight for each exposure of the set of exposures; and determining the amount by which each respective exposure of the set exposures contributes to the output image based on the respective exposure gain weight for each exposure of the set of exposures.

Aspect 12. The method of Aspect 11, further comprising determining the amount by which each respective exposure of the set of exposure contributes to the output image by applying the respective exposure gain weight associated with each exposure to each respective beginning time for each exposure.

Aspect 13. The method of Aspect 11, further comprising: determine a respective adjusted beginning time for each exposure of the set of exposures based on the original beginning time for each exposure of the set of exposures and the respective exposure gain weight associated with each exposure of the set of exposures.

Aspect 14. The method of Aspect 13, wherein adjusting the original beginning time comprises selecting an earliest beginning time from the adjusted beginning time for each exposure of the set of exposures as the adjusted beginning time.

Aspect 15. The method of Aspect 11, wherein the respective exposure time for each exposure of the set of exposures and the respective exposure gain weight for each exposure of the set of exposures are based on environmental conditions.

Aspect 16. The method of any of Aspects 9-15, wherein determining the time stamp for the output image comprises determining a middle between the adjusted beginning time and the end time to the exposure period.

Aspect 17. A non-transitory computer-readable medium having stored thereon instructions that, when executed by at least one processor, cause the at least one processor to: obtain a respective exposure time for each exposure of a set of exposures for an output image, wherein each respective exposure of the set of exposures contribute to the output image; determine a respective beginning time for each exposure of the set of exposures based on each respective exposure time and an end time to an exposure period for the set of exposures; determine an original beginning time based on each respective beginning time for each exposure of the set of exposures; adjust the original beginning time based on an amount by which each respective exposure of the set of exposures contribute to the output image to obtain an adjusted beginning time; and determine a time stamp for the output image based on the adjusted beginning time and the end time to the exposure period.

Aspect 18. The non-transitory computer-readable medium of Aspect 17, wherein the end time to the exposure period is predetermined.

Aspect 19. The non-transitory computer-readable medium of any of Aspects 17-18, wherein the instructions further cause the at least one processor to: obtain a respective exposure gain weight for each exposure of the set of exposures; and determine the amount by which each respective exposure of the set exposures contributes to the output image based on the respective exposure gain weight for each exposure of the set of exposures.

Aspect 20. The non-transitory computer-readable medium of Aspect 19, wherein the instructions further cause the at least one processor to determine the amount by which each respective exposure of the set of exposure contributes to the output image by applying the respective exposure gain weight associated with each exposure to each respective beginning time for each exposure.

Aspect 21. The non-transitory computer-readable medium of Aspect 19, wherein the instructions further cause the at least one processor to: determine a respective adjusted beginning time for each exposure of the set of exposures based on the original beginning time for each exposure of the set of exposures and the respective exposure gain weight associated with each exposure of the set of exposures.

Aspect 22. The non-transitory computer-readable medium of Aspect 21, wherein, to adjust the original beginning time, the instructions cause the at least one processor to select an earliest beginning time from the adjusted beginning time for each exposure of the set of exposures as the adjusted beginning time.

Aspect 23. The non-transitory computer-readable medium of Aspect 19, wherein the respective exposure time for each exposure of the set of exposures and the respective exposure gain weight for each exposure of the set of exposures are based on environmental conditions.

Aspect 24. The non-transitory computer-readable medium of any of Aspects 17-23, wherein, to determine the time stamp for the output image, the instructions cause the at least one processor to determine a middle between the adjusted beginning time and the end time to the exposure period.

Aspect 25. An apparatus for processing image data, the apparatus comprising: means for obtaining a respective exposure time for each exposure of a set of exposures for an output image, wherein each respective exposure of the set of exposures contribute to the output image; means for determining a respective beginning time for each exposure of the set of exposures based on each respective exposure time and an end time to an exposure period for the set of exposures; means for determining an original beginning time based on each respective beginning time for each exposure of the set of exposures; means for adjusting the original beginning time based on an amount by which each respective exposure of the set of exposures contribute to the output image to obtain an adjusted beginning time; and means for determining a time stamp for the output image based on the adjusted beginning time and the end time to the exposure period.

Aspect 26. The apparatus of Aspect 25, wherein the end time to the exposure period is predetermined.

Aspect 27. The apparatus of any of Aspects 25-26, further comprising: means for obtaining a respective exposure gain weight for each exposure of the set of exposures; and means for determining the amount by which each respective exposure of the set exposures contributes to the output image based on the respective exposure gain weight for each exposure of the set of exposures.

Aspect 28. The apparatus of Aspect 27, further comprising means for determining the amount by which each respective exposure of the set of exposure contributes to the output image by applying the respective exposure gain weight associated with each exposure to each respective beginning time for each exposure.

Aspect 29. The apparatus of Aspect 27, further comprising: means for determine a respective adjusted beginning time for each exposure of the set of exposures based on the original beginning time for each exposure of the set of exposures and the respective exposure gain weight associated with each exposure of the set of exposures.

Aspect 30. The apparatus of Aspect 29, wherein the means for adjusting the original beginning time comprises means for selecting an earliest beginning time from the adjusted beginning time for each exposure of the set of exposures as the adjusted beginning time.

Aspect 31. The apparatus of Aspect 27, wherein the respective exposure time for each exposure of the set of exposures and the respective exposure gain weight for each exposure of the set of exposures are based on environmental conditions around the apparatus.

Aspect 32. The apparatus of any of Aspects 25-31, wherein the means for determining the time stamp for the output image comprises means for determining a middle between the adjusted beginning time and the end time to the exposure period.

What is claimed is:

1. An apparatus for processing image data, the apparatus comprising:
at least one memory; and
at least one processor coupled to the at least one memory and configured to:
obtain a respective exposure time for each exposure of a set of exposures for an output image, wherein each respective exposure of the set of exposures contribute to the output image;
determine a respective beginning time for each exposure of the set of exposures based on each respective exposure time and an end time to an exposure period for the set of exposures;
determine an original beginning time based on each respective beginning time for each exposure of the set of exposures;
adjust the original beginning time based on an amount by which each respective exposure of the set of exposures contribute to the output image to obtain an adjusted beginning time; and
determine a time stamp for the output image based on the adjusted beginning time and the end time to the exposure period.

2. The apparatus of claim 1, wherein the end time to the exposure period is predetermined.

3. The apparatus of claim 1, wherein the at least one processor is further configured to:
obtain a respective exposure gain weight for each exposure of the set of exposures; and
determine the amount by which each respective exposure of the set exposures contributes to the output image based on the respective exposure gain weight for each exposure of the set of exposures.

4. The apparatus of claim 3, wherein the at least one processor is configured to determine the amount by which each respective exposure of the set of exposure contributes to the output image by applying the respective exposure gain weight associated with each exposure to each respective beginning time for each exposure.

5. The apparatus of claim 3, wherein the at least one processor is further configured to:
determine a respective adjusted beginning time for each exposure of the set of exposures based on the original beginning time for each exposure of the set of exposures and the respective exposure gain weight associated with each exposure of the set of exposures.

6. The apparatus of claim 5, wherein, to adjust the original beginning time, the at least one processor is further configured to select an earliest beginning time from the adjusted beginning time for each exposure of the set of exposures as the adjusted beginning time.

7. The apparatus of claim 3, wherein the respective exposure time for each exposure of the set of exposures and the respective exposure gain weight for each exposure of the set of exposures are based on environmental conditions around the apparatus.

8. The apparatus of claim 1, wherein, to determine the time stamp for the output image, the at least one processor is configured to determine a middle between the adjusted beginning time and the end time to the exposure period.

9. A method for processing image data, comprising:
obtaining a respective exposure time for each exposure of a set of exposures for an output image, wherein each respective exposure of the set of exposures contribute to the output image;
determining a respective beginning time for each exposure of the set of exposures based on each respective exposure time and an end time to an exposure period for the set of exposures;
determining an original beginning time based on each respective beginning time for each exposure of the set of exposures;
adjusting the original beginning time based on an amount by which each respective exposure of the set of exposures contribute to the output image to obtain an adjusted beginning time; and
determining a time stamp for the output image based on the adjusted beginning time and the end time to the exposure period.

10. The method of claim 9, wherein the end time to the exposure period is predetermined.

11. The method of claim 9, further comprising:
obtaining a respective exposure gain weight for each exposure of the set of exposures; and
determining the amount by which each respective exposure of the set exposures contributes to the output image based on the respective exposure gain weight for each exposure of the set of exposures.

12. The method of claim 11, further comprising determining the amount by which each respective exposure of the set of exposure contributes to the output image by applying the respective exposure gain weight associated with each exposure to each respective beginning time for each exposure.

13. The method of claim 11, further comprising:
determine a respective adjusted beginning time for each exposure of the set of exposures based on the original beginning time for each exposure of the set of exposures and the respective exposure gain weight associated with each exposure of the set of exposures.

14. The method of claim 13, wherein adjusting the original beginning time comprises selecting an earliest beginning time from the adjusted beginning time for each exposure of the set of exposures as the adjusted beginning time.

15. The method of claim 11, wherein the respective exposure time for each exposure of the set of exposures and the respective exposure gain weight for each exposure of the set of exposures are based on environmental conditions.

16. The method of claim 9, wherein determining the time stamp for the output image comprises determining a middle between the adjusted beginning time and the end time to the exposure period.

17. A non-transitory computer-readable medium having stored thereon instructions that, when executed by at least one processor, cause the at least one processor to:
obtain a respective exposure time for each exposure of a set of exposures for an output image, wherein each respective exposure of the set of exposures contribute to the output image;
determine a respective beginning time for each exposure of the set of exposures based on each respective exposure time and an end time to an exposure period for the set of exposures;
determine an original beginning time based on each respective beginning time for each exposure of the set of exposures;
adjust the original beginning time based on an amount by which each respective exposure of the set of exposures contribute to the output image to obtain an adjusted beginning time; and
determine a time stamp for the output image based on the adjusted beginning time and the end time to the exposure period.

18. The non-transitory computer-readable medium of claim 17, wherein the end time to the exposure period is predetermined.

19. The non-transitory computer-readable medium of claim 17, wherein the instructions further cause the at least one processor to:
obtain a respective exposure gain weight for each exposure of the set of exposures; and
determine the amount by which each respective exposure of the set exposures contributes to the output image based on the respective exposure gain weight for each exposure of the set of exposures.

20. The non-transitory computer-readable medium of claim 19, wherein the instructions further cause the at least one processor to determine the amount by which each respective exposure of the set of exposure contributes to the output image by applying the respective exposure gain weight associated with each exposure to each respective beginning time for each exposure.

21. The non-transitory computer-readable medium of claim 19, wherein the instructions further cause the at least one processor to:
determine a respective adjusted beginning time for each exposure of the set of exposures based on the original beginning time for each exposure of the set of exposures and the respective exposure gain weight associated with each exposure of the set of exposures.

22. The non-transitory computer-readable medium of claim 21, wherein, to adjust the original beginning time, the instructions cause the at least one processor to select an earliest beginning time from the adjusted beginning time for each exposure of the set of exposures as the adjusted beginning time.

23. The non-transitory computer-readable medium of claim 19, wherein the respective exposure time for each exposure of the set of exposures and the respective exposure gain weight for each exposure of the set of exposures are based on environmental conditions.

24. The non-transitory computer-readable medium of claim 17, wherein, to determine the time stamp for the output image, the instructions cause the at least one processor to determine a middle between the adjusted beginning time and the end time to the exposure period.

25. An apparatus for processing image data, the apparatus comprising:
means for obtaining a respective exposure time for each exposure of a set of exposures for an output image, wherein each respective exposure of the set of exposures contribute to the output image;
means for determining a respective beginning time for each exposure of the set of exposures based on each respective exposure time and an end time to an exposure period for the set of exposures;
means for determining an original beginning time based on each respective beginning time for each exposure of the set of exposures;
means for adjusting the original beginning time based on an amount by which each respective exposure of the set of exposures contribute to the output image to obtain an adjusted beginning time; and
means for determining a time stamp for the output image based on the adjusted beginning time and the end time to the exposure period.

26. The apparatus of claim 25, wherein the end time to the exposure period is predetermined.

27. The apparatus of claim 25, further comprising:
means for obtaining a respective exposure gain weight for each exposure of the set of exposures; and
means for determining the amount by which each respective exposure of the set exposures contributes to the output image based on the respective exposure gain weight for each exposure of the set of exposures.

28. The apparatus of claim 27, further comprising means for determining the amount by which each respective exposure of the set of exposure contributes to the output image by applying the respective exposure gain weight associated with each exposure to each respective beginning time for each exposure.

29. The apparatus of claim 27, further comprising:
means for determining a respective adjusted beginning time for each exposure of the set of exposures based on the original beginning time for each exposure of the set of exposures and the respective exposure gain weight associated with each exposure of the set of exposures.

30. The apparatus of claim 29, wherein the means for adjusting the original beginning time comprises means for selecting an earliest beginning time from the adjusted beginning time for each exposure of the set of exposures as the adjusted beginning time.
